(19) United States
(12) Patent Application Publication
(10) Pub. No.: US 2004/0249502 A1
(43) Pub. Date: Dec. 9, 2004

(54) Mobile vending solution for passenger carrying vehicles

(76) Inventors: Hung Chi Truong, Las Vegas, NV (US); Doug Baxendell, Rochester, NY (US); Grant E. Wylie, Honeoye, NY (US)

Correspondence Address: Marc A Vivenzio, Lorusso Loud & Kelly, Suite 312, 15 Rye Street, Portsmouth, NH, 03801, US

(21) Appl. No.: 10/490,127

(22) PCT Filed: Sep. 18, 2002
(86) PCT No.: PCT/US02/29433

Related U.S. Application Data
(60) Provisional application No. 60/323,672, filed on Sep. 18, 2001.

(51) Int. Cl. G07F 11/00; G06F 17/00

(52) U.S. Cl. 700/232; 221/78; 700/241; 700/237

(57) ABSTRACT

A mobile vending system (10) for passenger carrying commercial and private vehicles (100). The system (10) provides a means to vend prepackaged goods such as canned or bottled beverages, coffee, tea (22, 34, 35, 42) or solid items (23, 26, 28, 32). All vended goods are accessible to the passenger upon purchase. Also, the system (10) includes a means of providing a viewing of advertisements and a printer for coupons.

### CROSS-REFERENCE TO RELATED APPLICATIONS

This application claims the benefit of U.S. Provisional Application Ser. No. 60/323,672, filed on Sep. 18, 2001, the contents of which are incorporated by reference in their entirety.

### BACKGROUND OF THE INVENTION

This invention relates to a vehicle or hybrid vehicle integrated with a mobile vending solution. In particular, the invention relates to a mobile product vending system, particularly for use in taxicabs, commercial buses, family vans, rental vehicles and other similar vehicles.

Vending machines enable consumers to purchase products in a convenient manner. However, because vending machines are stationary, their user pool is limited to those who are aware of and have access to the sites where the stationary vending machines are located. Also, due to the ever-increasing number of hours that individuals spend in transport between destinations, it would be convenient if vending machines could travel with the individual during those hours of transport, especially since the individual could save time and effort in seeking out goods sold in stationary vehicles and convenience stores. Therefore a mobile vending solution is desirable and would offer significant advantages.

### SUMMARY OF THE INVENTION

The instant invention provides a mobile vending system and method for use in commercial and personal vehicles, thereby creating an additional source of income for taxicab owners and other operators/drivers. The intended products are food, beverages (both hot and cold), cigarettes, newspapers, prophylactics and other articles potentially sold through a conventional vending machine.

In one embodiment, the invention is a mobile vending system comprising: a controller subsystem for controlling the operation of the system and for producing an output that characterizes system charges; an order-entry subsystem for accepting customer input and sending signals to the controller subsystem; a cold beverage vending subsystem adapted for vending beverages in cans, the cold beverage vending subsystem including an inclined storage compartment, a cooling subassembly and a can-release mechanism; and a hot beverage vending subsystem adapted for vending beverages in cups having lids, the hot beverage vending subsystem including a conveyor belt subassembly for positioning the cups, a thermally-insulated container for storage of the hot beverage until it is dispensed, a pump for pressuring the thermally-insulated container, a dispending chamber having a nozzle for dispensing the hot beverage into the cups, and a valve for controlling the flow of the hot beverage to the dispensing chamber.

In another embodiment, the above mobile vending system further comprises: a solid-product vending subsystem, the solid-product vending subsystem including a compartment having a door and a sensor that sends a charge signal to the controller subsystem when said door is opened by said customer and a solid product is removed from the compartment.

In yet another embodiment, the order-entry subsystem comprises a touch-screen

selection interactive display. Preferably, the cold beverage inclined storage compartment has two levels, each of which is adapted to store three inclined stacks of cans. In an embodiment, the hot beverage dispensing chamber is adapted to push the nozzle through the lid of one of the cups during the dispensing operation. Preferably, the hot beverage vending subsystem further comprises a concentrate-dispenser subassembly for dispensing a liquid concentrate into one of said cups.

In another embodiment, the above mobile vending system further comprises a taxicab having a meter that is adapted to accept the output that characterizes system charges and add said charges to the fare of the customer using the system.

In another embodiment, the invention is also a method of operation of a mobile vending system. Preferably, the method comprises controlling the operation of the system and producing an output that characterizes system charges; accepting customer input and sending signals to a controller subsystem; vending beverages in cans by means of a cold beverage vending subsystem that may be provided by an inclined storage compartment, a cooling subassembly and a can-release mechanism; and vending beverages in cups having lids by means of a hot/cold beverage vending subsystem that includes a means of providing cups by either a conveyor belt subassembly for positioning the cups or a stack of cups which the top cup is removed and position for accepting the beverages, a thermal container for storage of the hot/cold beverage until it is dispensed in its final form, a pump for pressuring the thermal

container, a dispending chamber having a nozzle for dispensing the hot/cold beverage into the cups, and a valve for controlling the flow of the hot/cold beverage to the dispensing chamber. Optionally are multiple tanks of concentrates and a means of delivering the concentrate to the hot/cold beverage. A tank of compressed carbon dioxide provided to carbonize specific drinks selected by the customer.

In another preferred embodiment, the above method includes vending a solid product by means of a solid-product vending subsystem that includes a compartment for delivering the solid product to the customer. It may have a door and a sensor that sends a charge signal to the controller subsystem when said door is opened by said customer and a solid product is removed from the compartment. Another option is to have the customer select the desired solid product and the selected product is delivered to the customers reach for a dispensing point.

In use, the system is preferably re-supplied at the beginning of each day or a period time by a list provided to the driver of the contents remaining for sale. Optionally in use for fleets of cabs or other high volume businesses a mobile transmitting unit can forward the contents of the vending machine to a central location so that the refilling of the machine can be facilitated. Hot/cold beverage liquid (e.g., enough to fill at least twenty-four cups) is added to the thermal container and optionally at least two cups, but preferably twelve cups with lids are added to the conveyor. Additional cups are added to the system after the first cups are consumed. Another method is to have cups stacked and have them automatically removed and positioned from the stack for filling with the selected beverage. Exhausted concentrate dispensers are replaced with full ones. Cold beverage cans and solid items are also added to the system.

Preferably, the system is operated by a passenger being transported in a vehicle. The passenger enters a beverage product choice. The product choice may be made mechanically through a lever or button, electronically through a touch-screen display or other means to indicate the selected product and the system then dispenses the product. The passenger may also desire a solid product that in one embodiment may be selected by sliding open a door covering a solid product compartment and obtain a solid product. Another embodiment the product may be stored internally and transported to an area for access to the consumer once the selection has been made. The system calculates the charge associated with each product sale and sends a signal to the taxicab meter which causes it to add the charge to the passenger's fare or charged directly to the consumer at the point of sale through an acceptance of money or credit card charge.

If the embodiment contains a means for charging a credit card the cab fare can be charged to the passenger and limit access to the driver for safety. Another additional embodiment is the addition of a cellular phone for the passengers having a set billing rate for mobile calls to be made and charged to the passenger.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### BRIEF DESCRIPTION OF THE DRAWING

The features of the invention will be better understood by reference to the accompanying figures:

FIG. 1 is an isometric view of a particular embodiment of the invention.

FIG. 1a is a front elevation view of a particular embodiment of the invention.

FIG. 2 is a cross-sectional view of the prepackaged goods dispensing subsystem of a particular embodiment of the invention.

FIG. 2a is a side view of a particular embodiment of the invention in both the locked, ready to dispense position, and the prepackaged goods loading mode, slid towards the rare of the vehicle.

FIG. 3 is an elevation view of the liquid dispenser subsystem of a particular embodiment of the invention.

FIG. 4 is an isometric view of the liquid dispending chamber of a particular embodiment of the invention.

FIG. 5 is an isometric view of the cup and lid used in dispensing a liquid in a particular embodiment of the invention.

FIG. 5a is a side view of the lid of the liquid receptacle of a particular embodiment of the invention.

FIG. 6 is an isometric view of the upper portion of the liquid dispensing subsystem of a particular embodiment of the invention.

FIG. 7 is a front elevation view of the liquid dispenser of a particular embodiment of the invention.

FIG. 8 is a top plan view of the liquid receptacle conveying apparatus of a particular embodiment of the invention.

FIG. 8a is a cross-sectional view of the liquid receptacle conveying apparatus of a particular embodiment of the invention.

FIG. 9 is a top plan view of the liquid receptacle conveying apparatus of a particular embodiment of the invention.

FIG. 10 is a top view of a hybrid vehicle employing a mobile vending system according to a particular embodiment of the invention.

FIG. 11 is a block level diagram of a software program used to control a particular embodiment of the invention.

FIG. 12 is a block level diagram of the mobile vending control system of a particular embodiment of the invention.

FIG. 13 is a block level diagram of the system operating sequence of a particular embodiment of the invention.

FIG. 13a is a continuation FIG. 13.

FIG. 13b is a continuation of the FIG. 13.

FIG. 14 is a block level diagram product selection flowchart of a particular embodiment of the invention.

FIG. 15 is a cross-sectional view detailing can cradle dispending action of a particular embodiment of the invention.

### DETAILED DESCRIPTION OF THE INVENTION

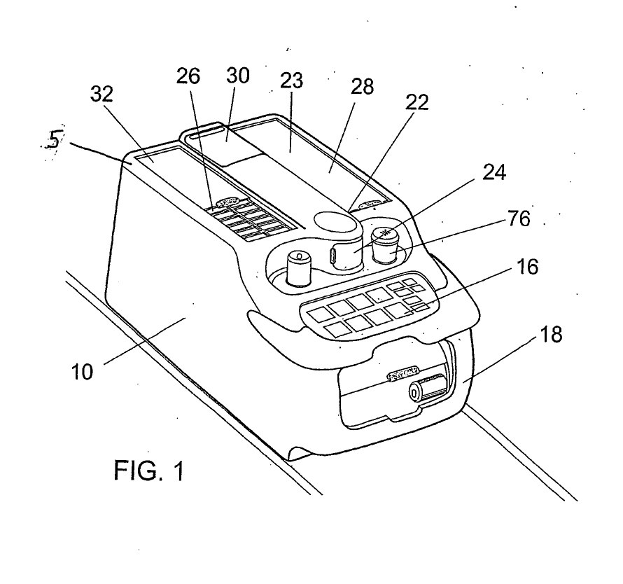

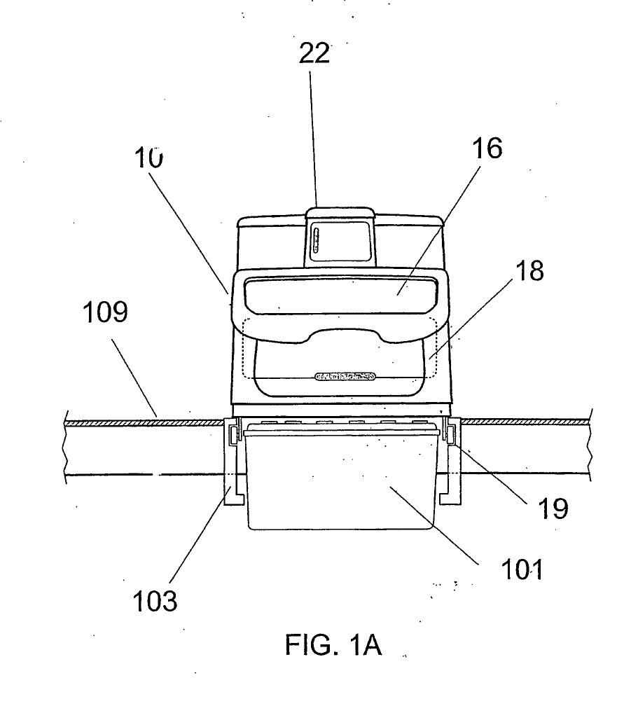

Referring to FIG. 1, an isometric view of a particular embodiment of the invention is presented. In this embodiment, automated mobile vending system 10 includes prepackaged goods dispensing subsystem 18, liquid dispensing subsystem 22, and solid goods dispensing subsystem 23. Automation of the operation of vending system 10 is computer controlled through a single board controller printed circuit board (PCB). In a particular embodiment the computer (not shown) comprises at least one microprocessor to operate the vending system, wherein the at least one microprocessor accepts inputs from a selector means and at least one memory storage device to store data associated with the system 10, wherein the at least one memory storage device stores inputs from the selector 16 and transmits the inputs to its accompanying microprocessor. In one embodiment, the selector means 16 of the vending unit 10 is provided with an order entry liquid crystal display (LCD) touch screen 16 which can be combined with a multi-media like video screen with sound. In such an embodiment, touch screen 16 also functions as an extended advertisement viewing platform. In another embodiment, system 10 also includes a printer (not shown) that outputs coupon printouts when a coupon request is input via touch screen 16, by passengers.

Mobile vending system 10, preferably identified as MobilVend™ unit, also features a built-in liquid (e.g., coffee, tea, carbonated beverages, juices, flavored drinks, beer, water, and any other liquid capable of being dispensed by the system) dispensing subsystem 22. Additional features include at least one solid goods compartments; however in one embodiment there are three compartments 26, 28, 32 for dispensing any solid goods capable of being dispensed by the system such as packaged foods, candies, donuts, cigarettes, tissues and the like, as well other sundry items. Each of these compartments is wired with a sensor switch that activates if a solid product is removed from the compartment and causes a charge signal to be generated. Each sensor switch measures the change in thickness, volume or weight of solid product in each compartment after the door to the compartment is opened.

Referring to FIG. 1A, a rearview of the MobilVend™ unit shown mounted flush to vehicle floor 109 through series of rollers 19. A ladder frame 103 supports and protects a row of batteries 101 and serves as a translation rail for the rollers 19. The MobilVend™ unit translates a finite distance longitudinally on this rail system when the unit is unlocked.

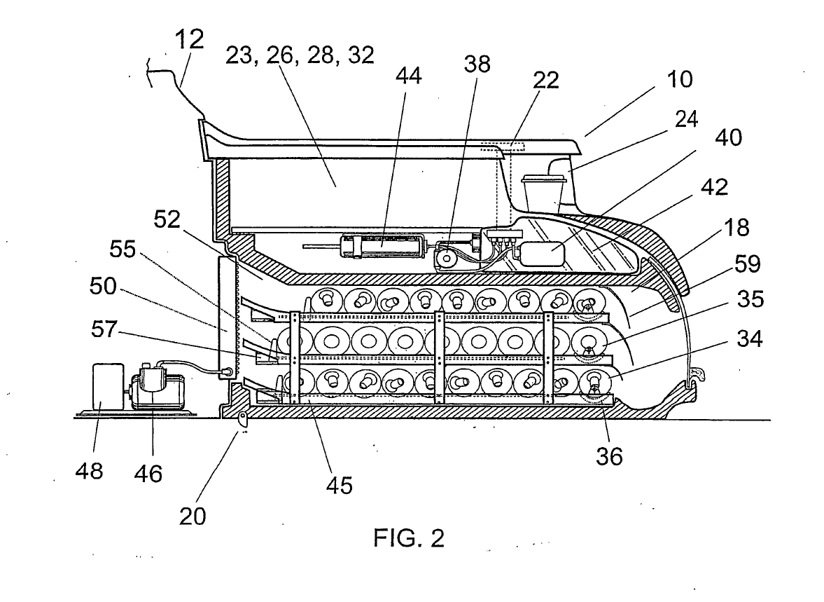

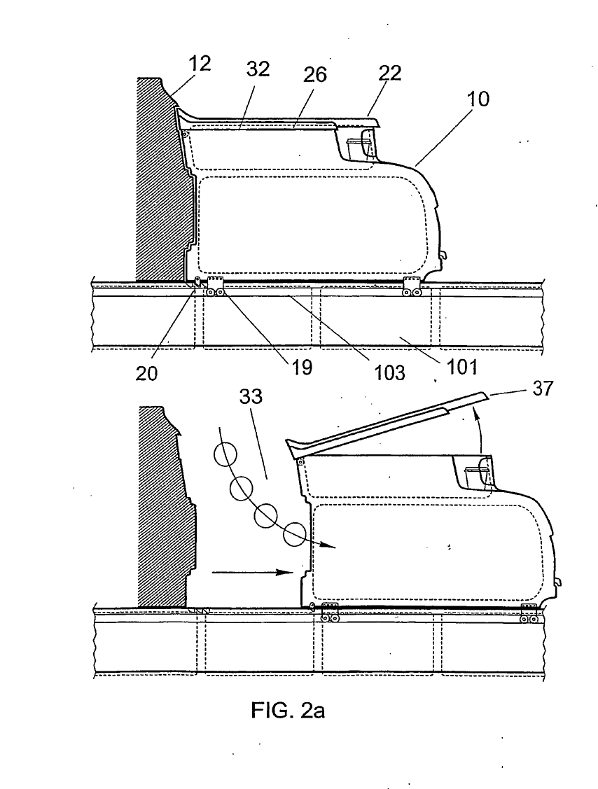

Referring to FIG. 2, a cross-sectional view of prepackaged goods dispensing subsystem 18 is shown, capable of dispensing all prepackaged goods capable of being dispensed by the system, including bottles and cans. In one embodiment of the invention, subsystem 18 is a cold beverage dispensing subsystem that comprises a prepackaged goods or beverage storage compartment 52 and a cradle mechanism for retaining, insulating and dispensing a single cold beverage can 34 or bottle 35, wherein the cradle mechanism can be solenoid or motor driven. In one embodiment the beverage storage compartment has at least two levels, and in another embodiment three levels 45, each of which accommodates three rows of cans 34 or two rows of bottles 35. Beverage storage compartment 52 is well insulated and maintained at a constant temperature. In a preferred embodiment, pusher plate 55, which is driven by stepper motor and lead screw 57, pushes the rows of beverage cans 34, and/or bottles 35 and/or other prepackaged goods (not shown). To load, unit 10 is translated backwards or forwards on rails depending on the configuration, where the stepper motor automatically reverses, moving pusher plate backwards so new cans 34 and/or bottles 35 and/or other prepackaged goods may be loaded. The cooling subassembly that maintains constant temperature comprises either a traditional unit that comprises compressor 46, condenser 48, and evaporator and fan 50, which may be mounted inside dashboard 12. Cooling may also be provided using electrical thermal cooler and fan.

As illustrated in FIG. 2, liquid dispensing subsystem 22 includes any liquid or premixed liquid either hot or cold stored inside a thermally-insulated container or chamber 42 with pump 38 maintaining a constant pressure in insulated auxiliary tank 40. If a hot liquid, such as coffee, is stored within the thermally insulated container 42, said liquid is maintained at a temperature between 120 and 160 degrees F., preferably about one hundred forty degrees F. by an electrical resistance heater (not shown). A first valve (not shown) opens periodically, circulating the liquid between the insulated auxiliary tank 40 and thermally insulated container 42 to keep it warm. When a customer/passenger/user/consumer makes a selection, a second valve (not shown) opens to dispense the liquid into a cup, adding at least one additive such as cream concentrate and/or a sugar or sugar/flavor concentrate by the customer. The system 10 is adapted to utilize any practical additive capable of being added to the liquid by the system 10. As an alternative to coffee, thermally insulated container 42 could also contain another hot beverage such as tea or hot chocolate. If a cold soft drink type liquid beverage is desired, a carbonation system can me added to provide carbonation to the liquid in the container 42.

Referring to FIG. 2a, a side view of MobilVend™ unit 10 showing normal operating position as well as can/bottle loading position via a loading system described below. Cans containing cold beverages and/or other prepackaged goods are introduced into the cold beverage or prepackaged goods dispensing subsystem 18 by the operator through opening 30, which is made accessible when MobilVend™ unit 10 is translated towards the rear of the vehicle, but again in some applications, the unit 10 may translate in any direction depending on the specific set-up within the housing vehicle. Via the loading system, the vending unit 10 is attached to rails in the vehicle floor through a series of rollers. These rollers allow easy translation when the unit is unlocked. Restocking of cans and/or bottles and/or other prepackaged goods can only take place while vehicle is parked and slide lock 20 is retracted. Snacks and sundries compartments can be reloaded by opening top cover 37. This cover cannot open unless unit 10 has been moved away from vehicle dashboard 12.

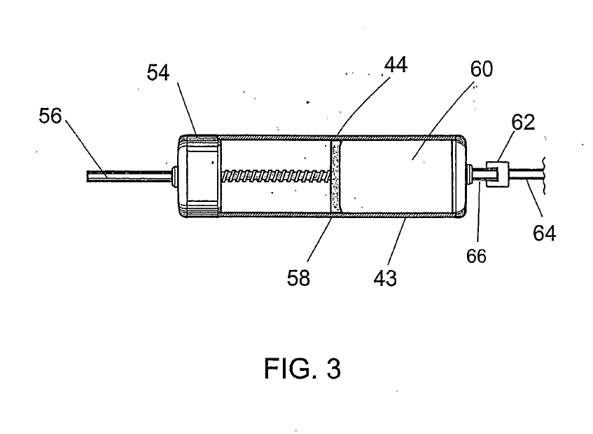

Referring to FIG. 3, an elevation view of additive or concentrate dispenser assembly 44 of a particular embodiment of the invention is presented. As shown in FIG. 2, additive dispenser subassembly 44 includes lead screw 56, stepper motor 54, aluminum or stainless steel dispensing tube 43, plastic or aluminum plunger plate 58, sugar/cream flavor concentrate 60, check valve 66, quick connect 62, and plastic tubing 64. When stepper motor 54 is activated, lead screw 56 turns, causing plunger plate 58 to apply pressure constantly to sugar or cream concentrate 60. This causes check valve 66 to open while at least one additive 60 flows through quick disconnect 62 and tubing 64, out of dispensing nozzle 70 and into a cup or other suitable receptacle means 76. After cup 76 is filled, the customer slides door 24 open and retrieves the cup 76.

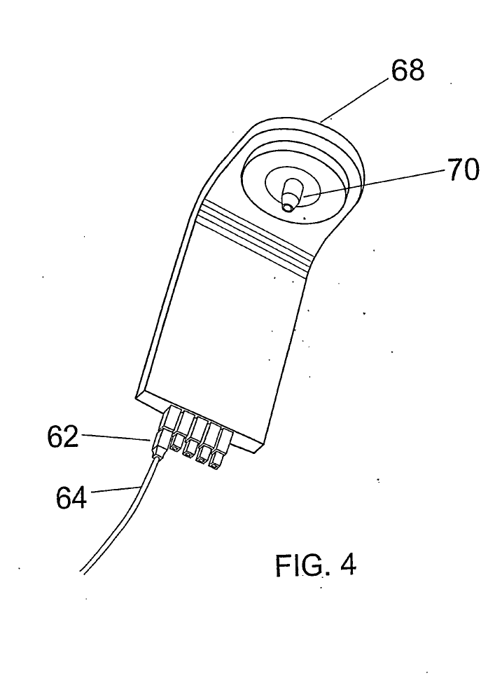

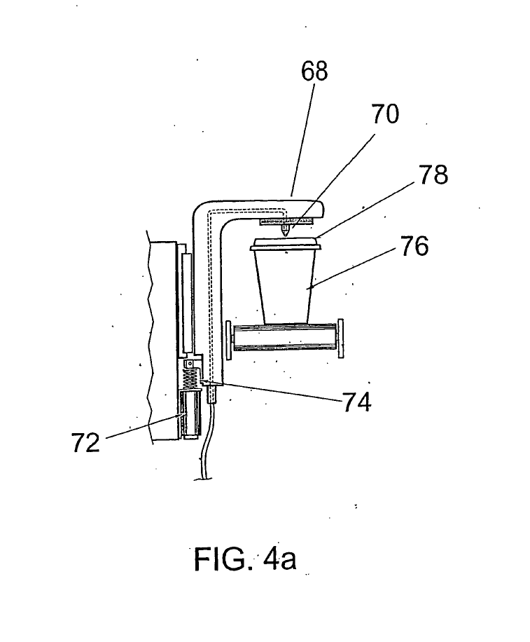

Referring to FIG. 4, an isometric view of liquid or beverage dispensing chamber 68, of a particular embodiment of the invention, is presented. Liquid beverage dispensing chamber 68 is shown connected to beverage supply tubing 64 where hot or cold water, other liquids, and additives such as cream and sugar are introduced to the dispenser. In FIG. 4A, a side view of liquid dispensing chamber 68 is presented. Liquid dispensing chamber 68 is shown connected to liquid supply tubing 64 by means of quick disconnect coupling 62. Solenoid 72 connects liquid or coffee dispensing chamber 68 to the structure of system 10 via a side flange. When solenoid 72 is activated, nozzle 70 is moved downward and penetrates lid 78 on cup 76. A second valve (not shown) opens, allowing a selected amount of liquid to flow into awaiting cup 76. After a set period of time, solenoid 72 is switched off, allowing springs 74 to decompress, pushing dispensing chamber 68 and nozzle 70 back into their initial positions.

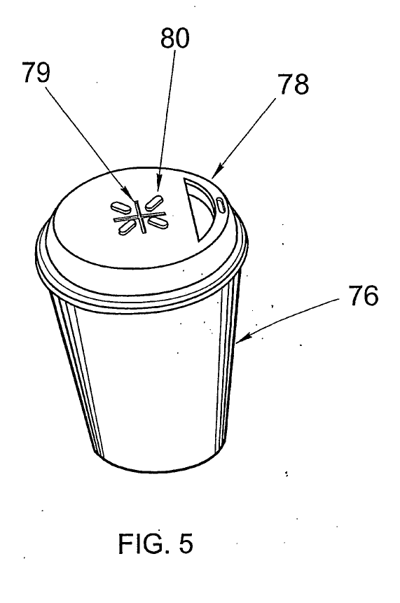

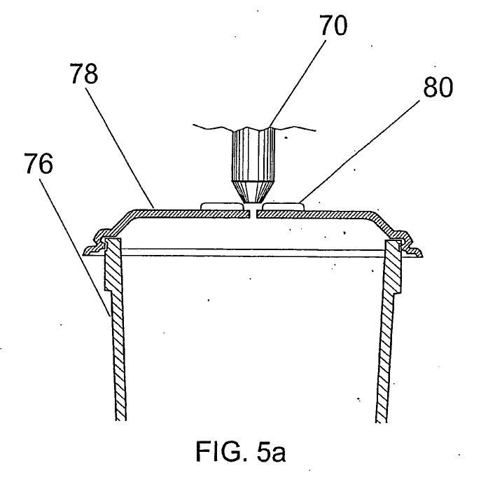

Referring to FIG. 5, an isometric view of receptacle or cup 76 and lid 78 used in dispensing hot beverages, cold beverages or other liquids in a particular embodiment of the invention is presented. FIG. 5A. presents a side view of lid 78 and cup 76. Cup 76 and lid 78 are designed in such a way that output nozzle 70 can easily push through center, cross, cutout 79 by first making contact with bumps 80 on lid 78. Bumps 80 aid nozzle 70 in pushing open center, cross, cutout 79 and spring back into their original positions once nozzle 70 is retracted.

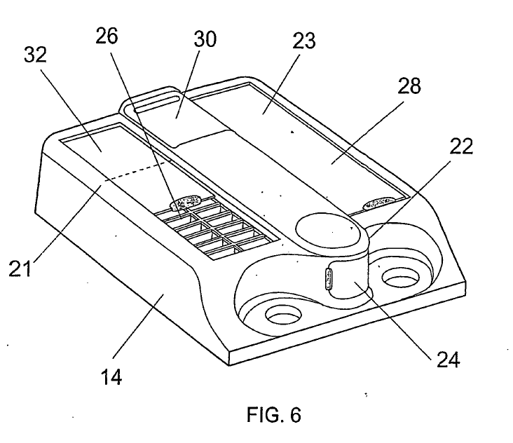

Referring to FIG. 6, an isometric view of upper portion 14 of the liquid and/or hot beverage dispensing subsystem 22, of a particular embodiment of the invention is shown. Upper portion 14 includes see-through coffee cup dispenser cover 24, which is opened by the passenger to retrieve a cup of hot beverage (or cold beverage) and access door 30 which is opened by the operator for loading cup 76 and lid 78 assemblies. Upper portion 14 also contains solid goods (including snack and sundry goods) dispensing subsystem 23, which includes, in a particular embodiment, snacks compartment 26, donuts compartment 28 and cigarettes and tissues compartment 32. Front compartments are fully accessible with slide open. Compartments towards the taxi dash are reserved for age dependent products and are accessible only if driver releases age sensitive access door lock 21, on sliding door. When a solid product is removed from a compartment, the sensor/micro-switch activates, causing charges to be posted directly to the taximeter. An itemized fare including all products removed will be presented to customer.

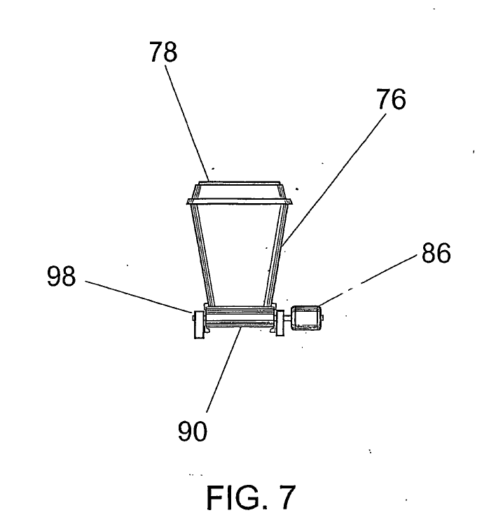

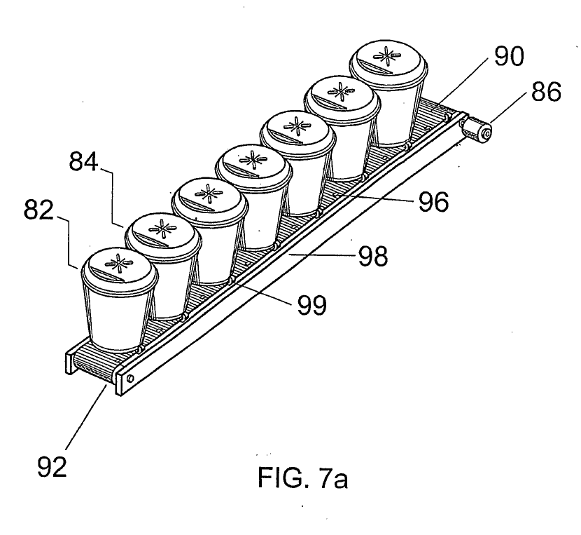

Referring to FIG. 7, a front elevation view of hot beverage delivery conveyor belt subassembly or liquid receptacle conveying apparatus 98 of a particular embodiment of the invention is depicted. FIG. 7A presents an isometric view of liquid receptacle conveying apparatus 98; said apparatus can be a conveyer belt as shown or any other conveying means such as a hopper or dispenser. Rubber conveyor belt 90 is driven by two geared rollers 92, one on each end of belt 90 with stepper motor 86 attached directly to geared roller at one end as shown. Belt 90 itself has teeth on its inside surface and small fingers 99 on the outside surface of belt 90 for cup alignment. Belt 90 is also perforated with belt notches or perforations 96 that can be sensed by an optical sensor (not shown). Conveyor belt subassembly 98 first moves a cup to initial position 84, in which position it is ready to be filled with a liquid. After an order for a liquid beverage is placed, system 10 determines whether a foreign object is in service position 82. If that is the case, a message is displayed on touch screen 16 asking the passenger to open cover 24 and remove the foreign object. If service position 82 is empty, an empty cup is automatically moved to initial position 84. At initial position 84, the cup is filled with a cold or hot liquid beverage and then the filled cup moved into service position 82. When the cup reaches service position 82, a message is displayed on touch screen 16 asking the passenger to open cover 24 and remove the purchased cup of liquid beverage.

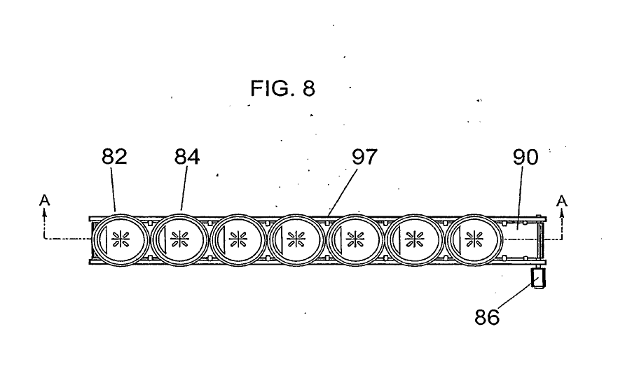

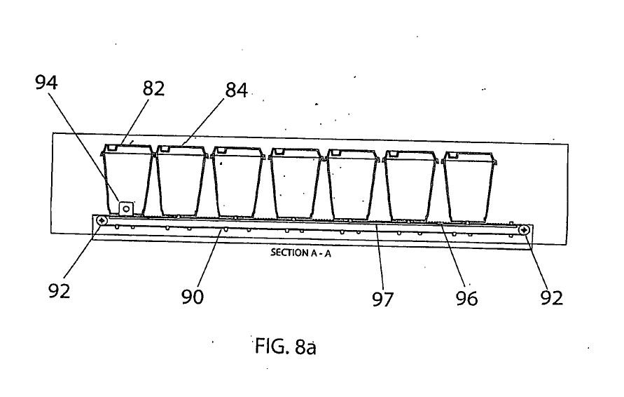

Referring to FIG. 8, a top plan view of the conveyor belt subassembly 98 of a preferred embodiment of the invention is presented. FIG. 8A presents a cross-sectional view of the conveyor belt subassembly 98. In these figures, one filled cup is in service position 82 and a second cup is in initial position 84, ready to be filled with a hot beverage. Also shown are notches 96 that are visible by optical/mechanical sensor switches and stepper motor 86.

FIG. 8A shows conveyor belt 90 mounted on two gear rollers 92, one located at each reversal of direction of belt 90. Optical cup-location-detection sensor 94 is mounted between belt 90 and fixture plate 97 and detects each cut-out 96. Fixture plate 97 comprises a plurality of stationary rollers or a flat, low-coefficient-of-friction plastic (e.g., Delrin^{R} or equivalent material) plate fixture located beneath the top run belt 90 to function as a support and prevent belt 90 from sagging.

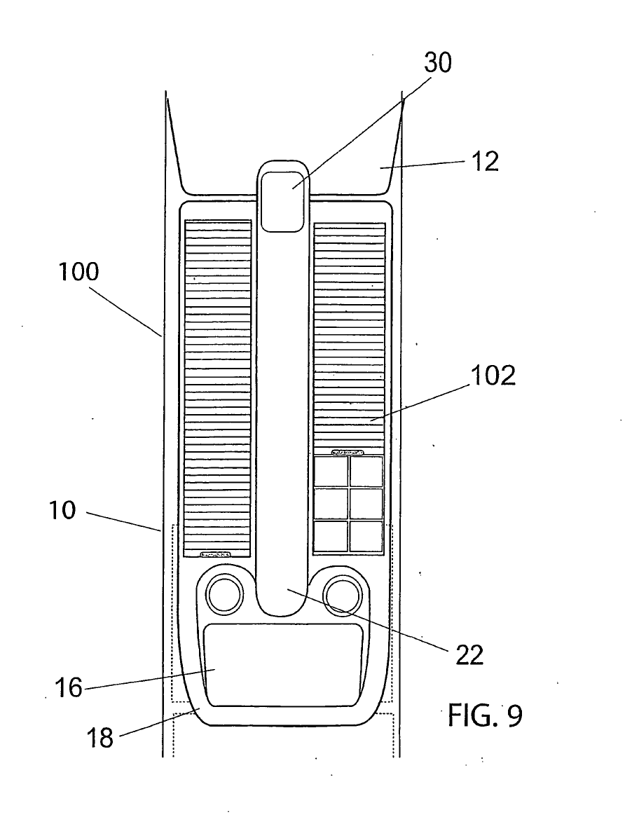

Referring to FIG. 9, a top plan view of another preferred embodiment of the invention is presented. This embodiment comprises automated mobile vending system 10 installed in taxicab 100. Supplies for automated mobile vending system 10 are stored in storage cabinet 102. In another preferred embodiment (not shown), system 10 is equipped with an airbag to protect passengers from colliding directly with the body of system 10 during a collision.

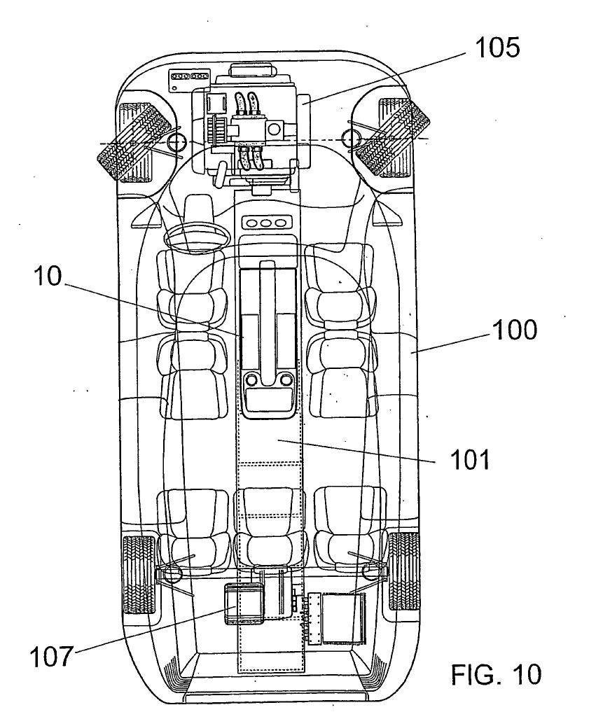

Referring to FIG. 10, a top plan view of yet another preferred embodiment of the invention is presented. This embodiment also comprises automated mobile vending system 10 installed in taxicab 100. In this embodiment, taxicab 100 is a hybrid vehicle that comprises generator 105 and electric motor 107 and series of batteries 101.

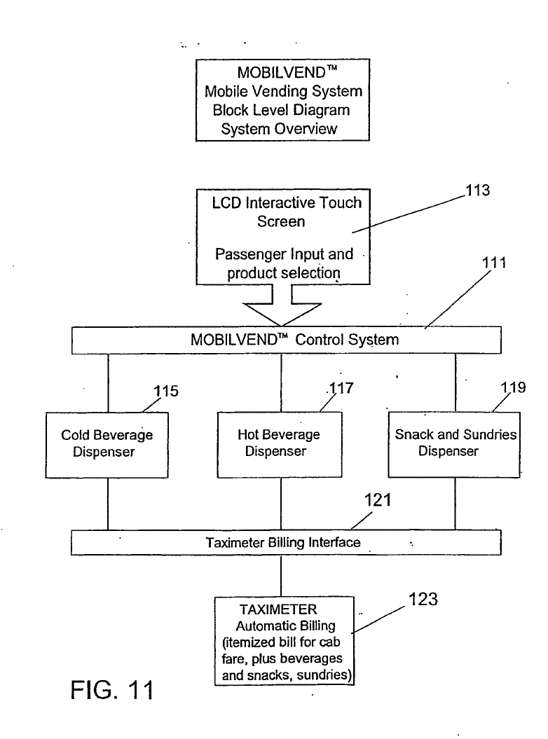

Referring to FIG. 11, a block level diagram of a software program used to control a preferred embodiment of the invention is presented. In a preferred embodiment, the software program is comprised of objects that model the real world objects of the invention. As indicated in FIG. 11, passenger input and product selection to MobilVend™ control system object 111 occurs via LCD interactive touch screen object 113. MobilVend™ control system object 111 sends control messages to the prepackaged or cold beverage dispenser object 115, liquid or hot beverage dispenser object 117 and the solid goods and snack and sundry dispenser 119. After a product is dispensed, prepackaged or cold beverage dispenser object 115, liquid or hot beverage dispenser object 117 and solid goods or snack and sundry dispenser 110 send messages characterizing charges to a taximeter billing interface object 121 which interacts with taximeter object 123.

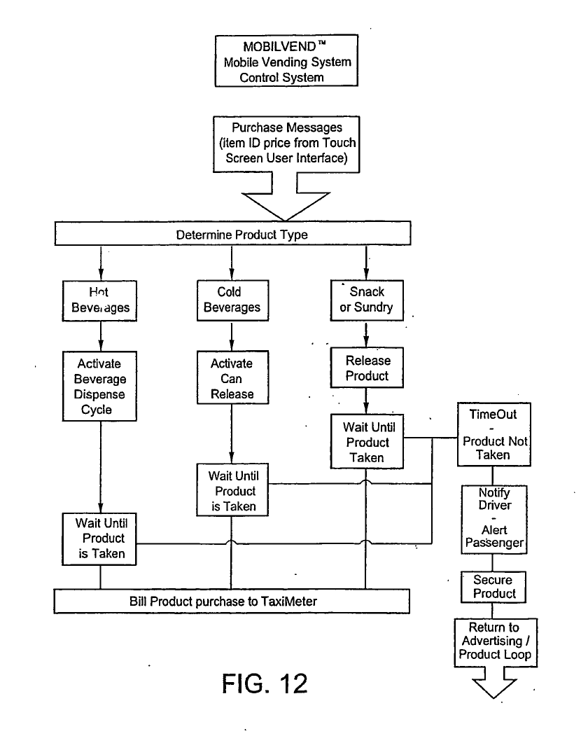

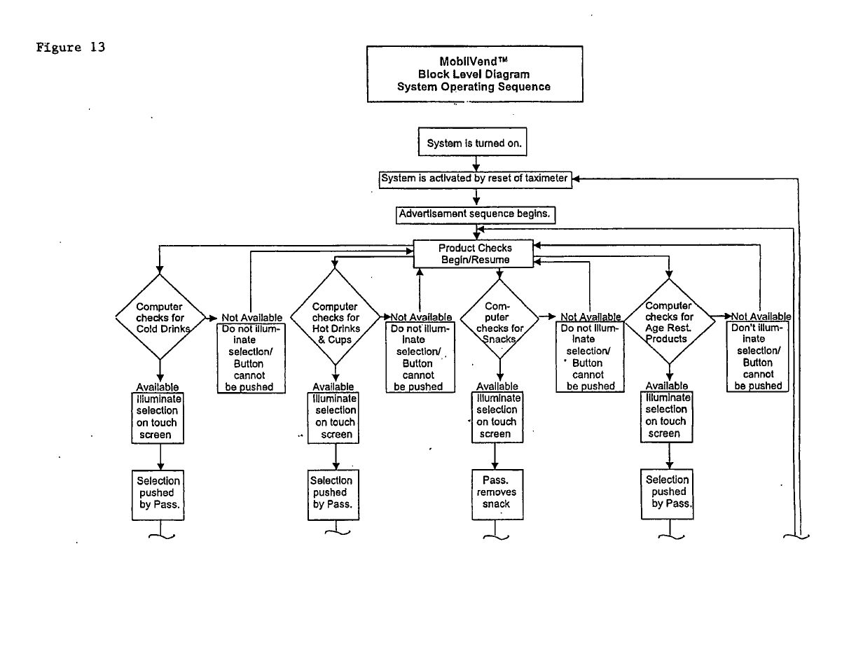

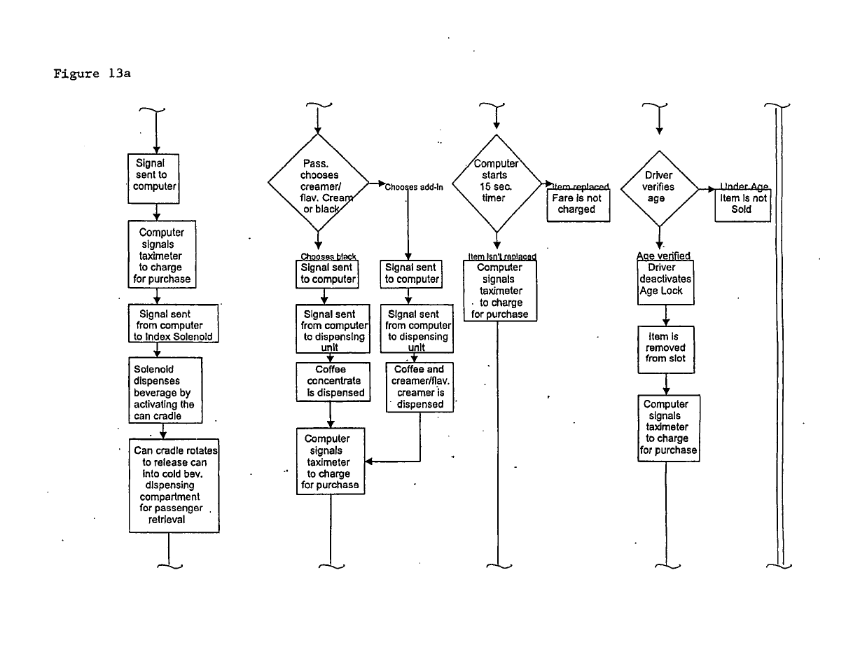

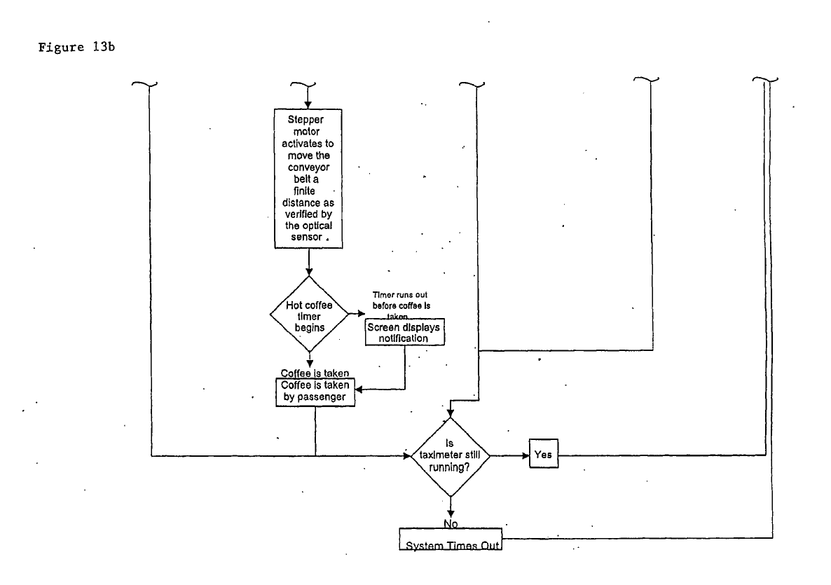

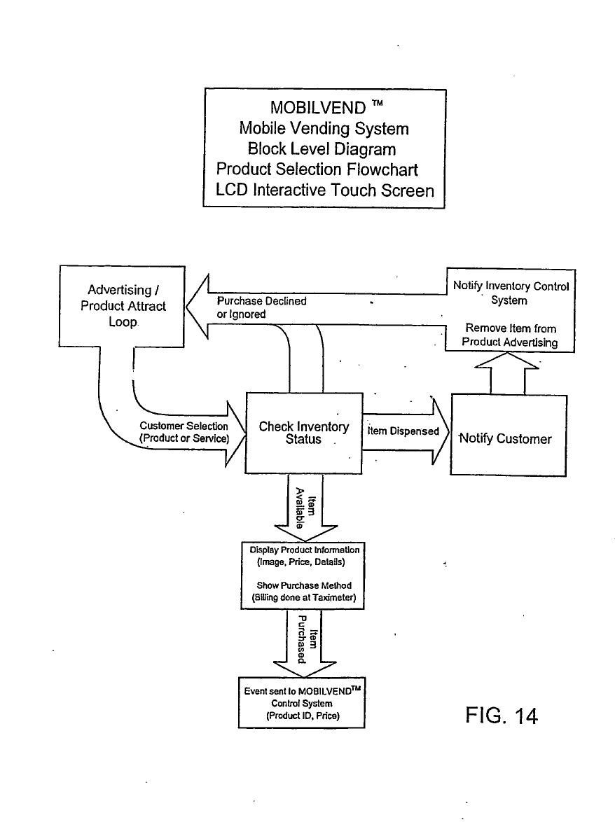

Referring to FIGS. 12-14, the mobile vending control system, system operating sequence and product selection flowchart are respectively shown in accordance with one embodiment of the invention

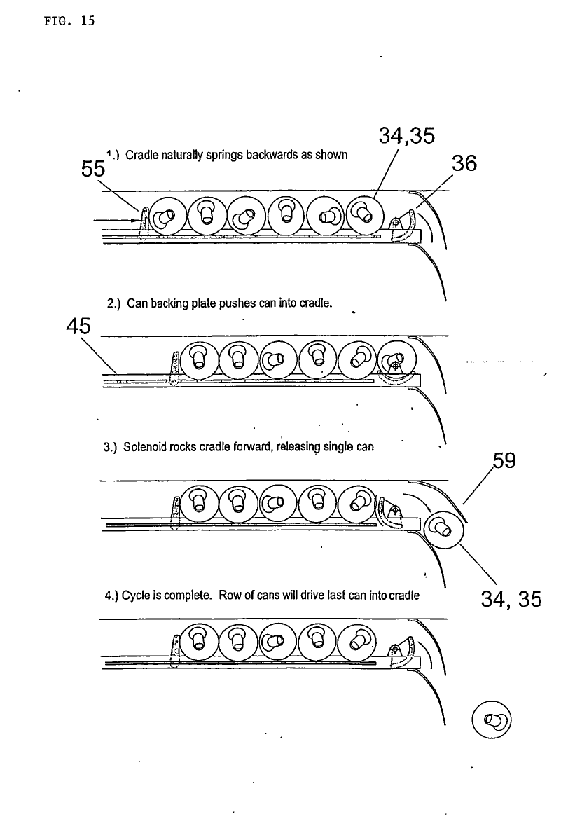

Referring to FIG. 15, A side view detail of the can cradle delivery subsystem is described. Due to vehicle movements, a gravity fed delivery system would be unreliable. The cradle subsystem holds and delivers a single can or prepackaged good when selected. The cradle mechanism 36 pivots on each side, and naturally rotates back when empty. As cans 34 or bottles 35 or other prepackaged goods are pushed back by can pusher plate 55, the first can or bottle causes the cradle to center and lock in this position. A drive rack is driven by solenoid, which rotates cradle forward, delivering the single can or bottle. The a cradle mechanism 36 ultimately retains all prepackaged goods including bottles and cans and is not affected by the acceleration and deceleration of the vehicle and is not affected by the slope and direction of the path of travel of the vehicle.

In one embodiment of the invention, the mobile vending system 10 comprises a housing 5 having an inside and an outside, wherein the housing is adapted for incorporation into a vehicle; at least one storage compartment affixed within the inside of the housing for storing goods; a dispensing system, wherein the goods dispensed are conveyed from the at least one storage compartment to the outside of the housing; and at least one selector device in communication with the dispensing system.

In this embodiment, the dispensing system further comprises: an optional prepackaged goods dispensing subsystem 18 comprising: a prepackaged goods storage compartment; a cradle mechanism for retaining and dispensing a prepackaged good, wherein operation of the cradle mechanism is not affected by the acceleration and deceleration of the vehicle and is not affected by the slope and direction of the path of travel of the vehicle; and a delivery mechanism for advancing the prepackaged goods stored in the prepackaged goods storage compartment after a prepackaged good is dispensed.

Additionally, and optionally, dispensing system further comprises: 22 a liquid dispensing subsystem comprising: at least one thermally insulated container 42 for storing a liquid; at least one pump 38 in fluid communication with the container; tubing means 43 for liquid travel in fluid communication with the container; at least one valve in fluid communication with the container; and a liquid dispenser in fluid communication with the container having at least one nozzle for dispensing the liquid. The liquid dispensing subsystem further comprises: a liquid receptacle conveying apparatus comprising, at least one receptacle delivery device, which can be a conveyor 90; and at least one receptacle 76 having an opening for receiving the dispensed liquid, wherein the receptacle is stored in the delivery device. Also, liquid dispensing subsystem further comprises a carbonation unit (not shown) capable of carbonating the dispensed liquid and at least one additive dispenser for dispensing at least one additive to the dispense liquid.

Lastly, and optionally, the dispensing system comprises a solid goods dispensing subsystem comprising: at least one solid goods compartment; and at least one lockable access door defined in the housing for allowing access to the solid goods stored in the compartment, wherein at least one access door comprises an age restriction device for controlling access to the corresponding solid goods compartment.

The system 10 employs a computer, which performs multiple tasks, one of which is running a program which assists in operating the system 10. In one embodiment the computer program comprises the steps of: turning on the vending system 10; activating the system via an electronic signal from a taximeter; starting the advertisement sequence on a video screen; checking inventory of goods stored in at least one storage compartment; illuminating choice on selector device 16 for available goods; reading selection by user from a touch screen input corresponding to an associated good; activating the dispensing system and an appropriate dispensing subsystem associated with the touch screen input, wherein if a liquid is the chosen good, a liquid dispensing subsystem 22 comprising a liquid dispenser, additive dispenser and a liquid receptacle conveying subsystem is activated, if a prepackaged good is the chosen good, a prepackaged goods dispensing subsystem 18 comprising a cradle mechanism and a delivery mechanism is activated, if a solid good is the chosen good, a solid goods dispensing subsystem 23 comprising a lockable lid located within the housing is activated, and if an age restricted solid good is the chosen good, the solid goods dispensing subsystem further comprising an age restricted monitor is activated; dispensing at least one quantity of liquid if liquid is selected; dispensing at least one prepackaged good if a sealed liquid is selected; dispensing at least one solid good if a solid good is selected; dispensing at least one age restricted solid good if an age restricted solid good is selected and proper age is verified; determining the total quantity of goods dispensed; sending a signal to the taximeter to charge a fee equal to the total value of the dispensed goods in addition to transportation fees; and timing out the system if the taximeter stops running to reset the system.

Other options of the system embodiment include: at least one sensor in communication with the computer for determining the inventory levels of goods stored in the storage compartment; a transmitting device to relay information pertaining to the inventory levels of goods stored in the storage compartment to a location outside the vehicle; at least one indicator for communicating the inventory levels of goods stored in the storage compartment to the vehicle operator; at least one interactive display interface touch screen capable of accepting inputs and transmitting information to the passenger regarding availability of goods and allowing a passenger to select a desired good for purchase; at least one touch screen is capable of displaying advertisements to a passenger in the vehicle; a printing device capable of printing receipts and coupons selected by a passenger via the at least one touch screen; an interactive media system, comprising at least one video screen for visually providing information to a person in the vehicle; a sound system to co-act with the video screen; a taximeter that is adapted to accept an output associated with system charges and add the charges to the transportation fare of the passenger; a mobile communication system comprising a device capable of transmitting telephone calls and a meter for calculating telephone call charges and transmitting the charges to the vehicle operator; and a credit card reader for accepting electronic payment information to authorize debit and credit card purchases of goods including phone charges and transportation fare.

In use, the system 10 provides a method of providing goods for purchase in a mobile environment comprising the steps of: providing a vehicle, which can be a taxicab 100 capable of accepting a mobile vending system 10 having a housing 5; providing at least one storage area for storing goods for purchase; providing a selector device 16 for accepting at least one input associated with a specific good for purchase; reading the selected input; cross-referencing the input with the associated good for purchase; and delivering the selected good to a purchaser.

Many variations of the invention will occur to those skilled in the art. Some variations include means for vending liquids, hot beverages, cold beverages and/or solid products. Other variations call for a hybrid vehicle integrated with mobile vending solution. All such variations are intended to fall within the scope and spirit of the invention. It should be appreciated that the liquids, solid products and prepackaged goods noted in the description are only a portion of the full realm of items capable of being dispensed by the system 10, and therefore, any such item capable of being dispensed by the system 10 are intended to fall within the scope of the present invention.

We claim:

1. A mobile vending system comprising:
a housing having an inside and an outside, wherein the housing is adapted for incorporation into a vehicle;
at least one storage compartment affixed within the inside of the housing for storing goods;
a dispensing system, wherein the goods dispensed are conveyed from the at least one storage compartment to the outside of the housing; and
at least one selector device in communication with the dispensing system.

2. The mobile vending system of claim 1, wherein the vehicle is capable of carrying passengers.

3. The mobile vending system of claim 1, wherein the dispensing system dispenses solid goods.

4. The mobile vending system of claim 1, wherein the dispensing system dispenses prepackaged goods.

5. The mobile vending system of claim 1 wherein the dispensing system dispenses liquids.

6. The mobile vending system of claim 1 wherein the dispensing system further comprises:
a prepackaged goods dispensing subsystem comprising:
a prepackaged goods storage compartment;
a cradle mechanism for retaining and dispensing a prepackaged good, wherein operation of the cradle mechanism is not affected by the acceleration and deceleration of the vehicle and is not affected by the slope and direction of the path of travel of the vehicle; and
a delivery mechanism for advancing the prepackaged goods stored in the prepackaged goods storage compartment after a prepackaged good is dispensed.

7. The mobile vending system of claim 6, wherein the prepackaged goods storage compartment is thermally insulated.

8. The mobile vending system of claim 6, wherein the prepackaged goods storage compartment is comprised of at least two levels for separating prepackaged good varieties.

9. The mobile vending system of claim 6, wherein the delivery mechanism is a stepper motor and a lead screw combination.

10. The mobile vending system of claim 1, wherein the dispensing system further comprises:
a liquid dispensing subsystem comprising:
at least one thermally insulated container for storing a liquid;
at least one pump in fluid communication with the container;
tubing means for liquid travel in fluid communication with the container;
at least one valve in fluid communication with the container; and
a liquid dispenser in fluid communication with the container having at least one nozzle for dispensing the liquid.

11. The mobile vending system of claim 10, wherein the liquid dispensing subsystem further comprises:
a liquid receptacle conveying apparatus comprising:
at least one receptacle delivery device; and
at least one receptacle having an opening for receiving the dispensed liquid, wherein the receptacle is stored in the delivery device.

12. The mobile vending system of claim 11, wherein the receptacle delivery device is a conveyer belt.

13. The mobile vending system of claim 11, wherein the receptacle delivery device is a hopper.

14. The mobile vending system of claim 10, wherein the liquid dispensing subsystem further comprises a carbonation unit capable of carbonating the dispensed liquid.

15. The mobile vending system of claim 10, wherein the liquid dispensing subsystem further comprises at least one additive dispenser for dispensing at least one additive to the dispense liquid.

16. The mobile vending system of claim 15, wherein the additive dispenser comprises at least one dispensing tube mechanism for containing and dispensing at least one additive into the liquid and at least one valve for controlling the flow of the at least one additive.

17. The mobile vending system of claim 1, wherein the dispensing system further comprises:
a solid goods dispensing subsystem comprising:
at least one solid goods compartment; and
at least one lockable access door defined in the housing for allowing access to the solid goods stored in the compartment, wherein at least one access door comprises an age restriction device for controlling access to the corresponding solid goods compartment.

18. The mobile vending system of claim 1 further comprising:
a cooling system for cooling the at least one storage compartment.

19. The mobile vending system of claim 1 further comprising:
a heating system for heating the at least one storage compartment.

20. The mobile vending system of claim 1, further comprising:
a loading system, the loading system comprising:
a sliding mechanism in mechanical communication with the housing;
and a lockable cover defined in a portion of the housing.

21. The mobile vending system of claim 20, wherein the sliding mechanism comprises:
at least one rail affixed to the floor of the vehicle;
at least one set of rollers in mechanical communication with the housing, wherein the at least one set of rollers is slidably engagable with the at least one rail to allow the vending system to be displaced in a forward and backward direction; and
at least one locking mechanism which locks the rollers to secure the vending system in place.

22. The mobile vending system of claim 1 further comprising:
a computer comprising at least one microprocessor to operate the vending system, wherein the at least one microprocessor accepts inputs from the selector; and
at least one memory storage device to store data associated with the system, wherein the at least one memory storage device stores inputs from the selector and transmits the inputs to its accompanying microprocessor.

23. The mobile vending system of claim 22, wherein the at least one memory storage device further comprises a computer program for operating the mobile vending system.

24. The mobile vending system of 23, wherein the computer program comprises the steps of:
accepting at least one input from the selector device;
determining availability of the good associated with the input;
charging the value of the good associated with the input;
transmitting instructions to the dispensing system to dispense the selected good
associated with the input;
producing an electric signal to mechanically deliver the dispensed good associated with the input; and
Calculating the fee for the aggregate number of goods dispensed.

25. The mobile vending system of 23, wherein the computer program comprises the steps of:
turning on the vending system;
activating the system via an electronic signal from a taximeter;
starting the advertisement sequence on a video screen;
checking inventory of goods stored in at least one storage compartment;
illuminating choice on selector device for available goods;
reading selection by user from a touch screen input corresponding to an associated good;
activating the dispensing system and an appropriate dispensing subsystem associated with the touch screen input, wherein if a liquid is the chosen good, a liquid dispensing subsystem comprising a liquid dispenser, additive dispenser and a liquid receptacle conveying subsystem is activated, if a prepackaged good is the chosen good, a prepackaged goods dispensing subsystem comprising a cradle mechanism and a delivery mechanism is activated, if a solid good is the chosen good, a solid goods dispensing subsystem comprising a lockable lid located within the housing is activated, and if an age restricted solid good is the chosen good, the solid goods dispensing subsystem further comprising an age restricted monitor is activated;
dispensing at least one quantity of liquid if liquid is selected;
dispensing at least one prepackaged good if a sealed liquid is selected;
dispensing at least one solid good if a solid good is selected;
dispensing at least one age restricted solid good if an age restricted solid good is selected and proper age is verified;
determining the total quantity of goods dispensed;
sending a signal to the taximeter to charge a fee equal to the total value of the dispensed goods in addition to transportation fees; and
timing out the system if the taximeter stops running to reset the system.

26. The mobile vending system of claim 22 further comprising at least one sensor in communication with the computer for determining the inventory levels of goods stored in the storage compartment.

27. The mobile vending system of claim 26 further comprising:
a transmitting device to relay information pertaining to the inventory levels of goods stored in the storage compartment to a location outside the vehicle.

28. The mobile vending system of claim 1 further comprising at least one indicator for communicating the inventory levels of goods stored in the storage compartment to the vehicle operator.

29. The mobile vending system of claim 1, wherein the selector further comprises:
at least one interactive display interface touch screen capable of accepting inputs and transmitting information to the passenger regarding availability of goods and allowing a passenger to select a desired good for purchase.

30. The mobile vending system of claim 29, wherein the at least one touch screen is capable of displaying advertisements to a passenger in the vehicle.

31. The mobile vending system of claim 30 further comprising:
a printing device capable of printing receipts and coupons selected by a passenger via the at least one touch screen.

32. The mobile vending system of claim 1 further comprising:
an interactive media system, comprising at least one video screen for visually providing information to a person in the vehicle.

33. The mobile vending system of claim 32, wherein the interactive media system further comprises a sound system to co-act with the video screen.

34. The mobile vending system of 1 further comprising a taximeter that is adapted to accept an output associated with system charges and add the charges to the transportation fare of the passenger.

35. The mobile vending system of 1 further comprising an airbag safety system affixed to the housing.

36. The mobile vending system of claim 1 further comprising a mobile communication system comprising a device capable of transmitting telephone calls and a meter for calculating telephone call charges and transmitting the charges to the vehicle operator.

37. The mobile vending system of claim 1 further comprising:
a credit card reader for accepting electronic payment information to authorize debit and credit card purchases of goods including phone charges and transportation fare.

38. The mobile vending system of claim 1, wherein the vehicle is a taxicab.

39. A method of providing goods for purchase in a mobile environment comprising the steps of:
providing a vehicle capable of accepting a mobile vending system having a housing;
providing at least one storage area for storing goods for purchase;
providing a selector device for accepting at least one input associated with a specific good for purchase;
reading the selected input;
cross-referencing the input with the associated good for purchase; and
delivering the selected good to a purchaser.

40. The method of claim 39 further comprising the step of:
providing a pre-packaged goods dispensing subsystem comprising:
a prepackaged goods storage compartment;
a cradle mechanism for retaining and dispensing a prepackaged good, wherein operation of the cradle mechanism is not affected by the acceleration and deceleration of the vehicle and is not affected by the slope and direction of the path of travel of the vehicle; and
a delivery mechanism for advancing the prepackaged goods stored in the prepackaged goods storage compartment after a prepackaged good is dispensed.

41. The method of claim 40, wherein the prepackaged goods storage compartment is comprised of at least two levels for separating prepackaged good varieties.

42. The method of claim 39 further comprising the step of:
providing a liquid dispensing subsystem comprising:
at least one insulated container for storing a liquid;
at least one pump in fluid communication with the container;
tubing means for liquid travel in fluid communication with the container;
at least one valve in fluid communication with the container; and
a liquid dispenser in fluid communication with the container having at least one nozzle for dispensing the liquid.

43. The method of claim 42, wherein the liquid dispensing subsystem further comprises:
a liquid receptacle conveying apparatus comprising:
at least one receptacle delivery device; and
at least one receptacle having an opening for receiving the dispensed liquid, wherein the receptacle is stored in the delivery device.

44. The method of claim 42, wherein the liquid dispensing subsystem further comprises a carbonation unit capable of carbonating the dispensed liquid.

45. The method of claim 42, wherein the liquid dispensing subsystem further comprises at least one additive dispenser for dispensing at least one additive to the dispensed liquid.

46. The method of claim 39 further comprising the step of:
providing a solid goods dispensing subsystem comprising:
at least one solid goods compartment; and
at least one lockable access door defined in the housing for allowing access to the solid goods stored in the compartment, wherein the at least one compartment comprises an age restriction device for controlling access to the corresponding solid goods compartment.

47. The method of claim 39 further comprising the step of:
providing a cooling system for cooling the at least one storage compartment.

48. The method of claim 39 further comprising the step of:
providing a heating system for heating the at least one storage compartment.

49. The method of claim 39 further comprising the step of:
providing a loading system, the loading system comprising:
a sliding mechanism for sliding the vending system in position for loading;
a lock for holding the vending system in place; and
a lockable cover defined in a portion of the housing.

50. The method of claim 39 further comprising the step of:
providing a computer comprising at least one microprocessor to operate the vending system, wherein the at least one microprocessor accepts inputs from the selector; and at least one memory storage device to store data associated with the system, wherein the at least one memory storage device stores inputs from the selector and transmits the inputs to its accompanying microprocessor.

51. The method of claim 50, wherein the at least one memory storage device further comprises a computer program for operating the mobile vending system.

52. The method of claim 51, wherein the computer program comprises the steps of:
accepting at least one input from the selector device;
determining availability of the good associated with the input;
charging the value of the good associated with the input;
transmitting instructions to the dispensing system to dispense the selected good
associated with the input;
producing an electric signal to mechanically deliver the dispensed good associated with the input; and
Calculating the fee for the aggregate number of goods dispensed.

53. The method of claim 51, wherein the software program comprises the steps of:
turning on the vending system;
activating the system via an electronic signal from a taximeter;
starting the advertisement sequence on a video screen;
checking inventory of goods stored in at least one storage compartment;
illuminating choice on selector device for available goods;
reading selection by user from a touch screen input corresponding to an associated good;
activating the dispensing system and an appropriate dispensing subsystem associated with the touch screen input, wherein if a liquid is the chosen good, a liquid dispensing subsystem comprising a liquid dispenser, additive dispenser and a liquid receptacle conveying subsystem is activated, if a prepackaged good is the chosen good, a prepackaged goods dispensing subsystem comprising a cradle mechanism and a delivery mechanism is activated, if a solid good is the chosen good, a solid goods dispensing subsystem comprising a lockable lid located within the housing is activated, and if an age restricted solid good is the chosen good, the solid goods dispensing subsystem further comprising an age restricted monitor is activated;
dispensing at least one quantity of liquid if liquid is selected;
dispensing at least one prepackaged good if a sealed liquid is selected;
dispensing at least one solid good if a solid good is selected;
dispensing at least one age restricted solid good if an age restricted solid good is selected and proper age is verified;
determining the total quantity of goods dispensed;
sending a signal to the taximeter to charge a fee equal to the total value of the dispensed goods; and
timing out the system if the taximeter stops running to reset the system.

54. The method of claim 39, wherein the selector device is a touch screen capable of accepting inputs and transmitting information to the consumer regarding availability of goods and allowing a user to select a desired good for purchase.

55. The method of claim 39 further comprising the steps of:
providing video advertisements to passengers in the vehicle;

56. The method of claim 55 further comprising the steps of:
providing an interactive video display for showing the advertisements;
prompting for interactive responses from passengers;
tailoring advertisements to reflect response from passengers; and
providing coupons to passengers regarding advertisers' product or service.

57. The method of claim 39 further comprising the step of:
determining the total charges for the goods purchased and relaying the charges to the desired receiving party.

58. The method of claim 57, further comprising the step of:
providing a taximeter that is adapted to accept an output associated with system charges and add the charges to the transportation fare of the passenger using the system.

59. The method of claim 39 further comprising the steps of:
providing a means for accepting payment for dispensed goods.

60. The method of claim 39 further comprising the steps of:
providing a mobile communication system comprising a device capable of transmitting telephone calls and a meter for calculating telephone call charges.

61. The method of claim 39, wherein the vehicle is a taxicab.

62. A mobile vending system comprising:
a housing having an inside and an outside, wherein the housing is adapted for incorporation into a vehicle;
at least one storage means for storing goods, wherein the at least one storage means is affixed within the inside of the housing;
at least one dispensing means for dispending goods, wherein dispensed goods are conveyed from the at least one storage means to the outside of the housing;
at least one selector means for selecting goods, wherein the at least one selector means is in communication with the dispensing means; and
a means for calculating and charging fees for goods dispensed by the at least one dispensing means.

63. The mobile vending system of claim 62, wherein the vehicle is capable of carrying passengers.

64. The mobile vending system of claim 62, wherein the at least one dispensing means dispenses solid goods.

65. The mobile vending system of claim 62, wherein the at least one dispensing means dispenses pre-packaged goods.

66. The mobile vending system of claim 62, wherein the at least one dispensing system dispenses liquids.

67. The mobile vending system of claim 66, wherein the at least one dispensing means further comprises a liquid receptacle conveying means for transporting at least one receptacle stored therein.

68. The mobile vending system of claim 66, wherein the at least one dispensing means further comprises a means for carbonating a dispensed liquid.

69. The mobile vending system of claim 66, wherein the at least one dispensing means further comprises at least one additive dispensing means for dispensing at least one additive to a dispensed liquid.

70. The mobile vending system of claim 62 further comprising:
a temperature controlling means for regulating the temperature of the at least one storage means.

71. The mobile vending system of claim 62, further comprising a means for loading goods into the at least one storage means.

72. The mobile vending system of claim 62 further comprising a microprocessor means and software means for operating the system.

73. The mobile vending system of claim 62 further comprising at least one means for tracking and communicating the inventory of goods stored in the at least one storage means.

74. The mobile vending system of claim 62, wherein the selector further comprises:
an interactive interface capable of accepting inputs and transmitting information to the passenger regarding availability of goods and allowing a passenger to select a desired good for purchase.

75. The mobile vending system of claim 74, wherein the interactive interface is capable of displaying advertisements to a passenger in the vehicle.

76. The mobile vending system of claim 75, wherein the interactive interface further comprises a printing device capable of printing receipts and coupons based on passenger inputs.

77. The mobile vending system of claim 62, wherein the vehicle is a taxicab.
